(19) United States
(12) Patent Application Publication
(10) Pub. No.: US 2012/0281815 A1
(43) Pub. Date: Nov. 8, 2012

(54) X-RAY TUBE AND METHOD TO OPERATE AN X-RAY TUBE

(76) Inventors: Thomas Ferger, Fuerth (DE); Sven Fritzler, Breuberg-Sandbach (DE); Dieter Matuszok, Weisendorf (DE)

(21) Appl. No.: 13/456,586

(22) Filed: Apr. 26, 2012

(30) Foreign Application Priority Data
May 6, 2011 (DE) 10 2011 075 453.9

(51) Int. Cl. H01J 35/14

(52) U.S. Cl. 378/138

(57) ABSTRACT

An x-ray tube has an evacuated, rotatable housing in which are arranged a cathode designed to emit an electron beam and an anode interacting with this cathode, and two quadrupole magnet systems arranged outside of the housing and spaced apart from one another that are provided to influence the electron beam.

### BACKGROUND OF THE INVENTION

1. Field of the Invention

The present invention concerns an x-ray tube of the type having an evacuated, rotatable housing in which are arranged a cathode designed to emit an electron beam and an anode interacting with the beam, with a quadrupole magnet system arranged outside of the housing to affect the electron beam. The invention furthermore concerns a method to operate such an x-ray tube.

2. Description of the Prior Art

A rotary impeller x-ray tube of the above type is known from DE 196 31 899 A1, for example. Individual coil elements of a quadrupole magnet system are arranged on a common support.

Another x-ray tube with a quadrupole magnet system is known from DE 198 10 346 C1. In this case, in addition to the quadrupole magnet system, a coil spatially downstream of the quadrupole magnet system is provided with which the focal spot on the anode of the x-ray tube can be influenced.

In general, in electron sources such as those in x-ray tubes, the electrons in the beam mutually influence each other, which can lead to a significant degradation of the beam quality of the electron beam, which may possibly also degrade the generated x-ray beam, particularly at high emission currents.

A significant impairment of the focusing of an electron beam in an x-ray tube due to repulsion between the emitted electrons can be observed given a high tube current of more than 400 mA, in particular given a simultaneous relatively low tube voltage of less than 80 kV.

### SUMMARY OF THE INVENTION

An object of the invention is to further develop a rotary housing x-ray tube relative to the cited prior art, in particular with regard to the beam quality.

According to the invention, this object is achieved by an x-ray tube designed as a rotary envelope x-ray radiator with an evacuated, rotatable housing in which are arranged a cathode designed to emit an electron beam and an anode interacting with this cathode. The rotation axis of the housing corresponds to the beam direction in which the electrons are emitted from the cathode. To influence the electron beam, two quadrupole magnet systems are arranged axially one after another (relative to the rotation axis) between the cathode and the anode, preferably outside of the housing.

A good focusing of the electron beam can be achieved via the double quadrupole arrangement, even given low tube voltage (of 70 kV, for example) and at the same time high tube current of more than 550 mA. In particular given medical x-ray apparatuses, the quality of the electron beam significant affects the quality of the imaging.

Due to the focusing of the electron beam by the quadrupole doublet (i.e. the arrangement of two coaxial quadrupole magnet systems spaced apart from one another), a grid voltage at the electron source can be omitted or be used merely for fine optimization. In comparison to conventional x-ray tubes, a wider electron beam is provided via the entirely or nearly absent grid voltage, which leads to a relatively small mutual influencing of the electrons. Even at high electron currents (i.e. tube currents), only small spatial charges thus occur. The electrons fly in a broad beam parallel to the rotation axis of the housing (and therefore to the magnet axes of the quadrupole magnet systems), which is an optimal requirement for an efficient focusing via the quadrupole magnet systems. The electrons thus ultimately strike at a clearly defined focal spot on the anode, which provides for a high geometric quality of the x-ray radiation generated at the focal spot.

The two quadrupole magnet systems are preferably arranged with a rotational offset relative from one another relative to the rotation axis of the housing, meaning that their coils are arranged with a rotational offset from one another, thus the poles of the coils of the two systems that are arranged at the same rotation angle are swapped. An influencing of the electron beam in different directions that is sought by the two systems is thereby achieved.

An arrangement rotationally offset by 90° can be provided. Width and height of the electron beam can be specifically influenced by the arrangement (relative to the rotation axis of the housing) of the two quadrupole magnet systems—connected in series and spaced apart from one another—rotated by 90° relative to one another. The terms “width” and “height” of the electron beam refer to the two geometric axes that are orthogonal to the rotation axis of the housing and to one another, independent of the spatial arrangement of the x-ray tube.

According to a preferred embodiment, the two quadrupole magnet systems have identical dimensions. However, embodiments can also be realized in which the quadrupole magnet systems are dimensioned differently; for example, the quadrupole magnet system arranged closer to the anode is larger than the quadrupole magnet system arranged closer to the cathode.

In a further embodiment, at least one of the quadrupole magnet systems has two dipole coils in addition to four quadrupole coils. The magnet system having additional dipole coils can be either the quadrupole magnet system arranged closer to the anode or the quadrupole magnet system arranged closer to the cathode. Both magnet systems can likewise respectively have two dipole coils in addition to the already present quadrupole coils.

The quadrupole coils are advantageously respectively arranged in a corner of an advantageously quadratic yoke. Additional dipole coils are arranged if applicable at opposite sides of the yoke, respectively between two quadrupole coils.

A thermal emitter is appropriately provided as an emission source of the cathode. The electrons are therefore emitted via heating of the cathode with a corresponding heating voltage. The emitted electron stream is dependent both on the heating voltage and on the area of the emitter. With the arrangement of the two quadrupole magnet systems with their focusing properties, the particular advantage is achieved that the emitter (thus the emitter area) can be chosen to be larger in comparison to conventional arrangements. The radius of the circular area of the emitter is advantageously greater than or equal to 4 mm. Typical radii are 3 mm, which (given the circular emitters) leads to an enlargement of the emitter area by nearly double. In operation, a lower heat power thus can be applied to achieve the same high emission current that is achieved otherwise with a higher heat power, so the lifespan of the emitter can be markedly extended. Conversely, at the same time higher emission currents given comparable or lower heating temperatures than are typical can also be achieved.

An additional, particular advantage of the focusing with the quadrupole doublet is that the focusing of the electron beam can be (and advantageously also is) conducted exclusively via this quadrupole doublet. Therefore, no additional focusing electrode (to which what is known as a grid or gate voltage must be applied) is provided at the cathode. In presently used x-ray tubes, this grid voltage is (depending on the operating state) up to 1000V, relative to the cathode potential. This means that an electronic control unit of correspondingly complicated design must be provided. However, artifacts or flashovers that ultimately negatively affect the quality of the generated x-ray radiation (and therefore ultimately the quality of the medical image generation) consistently occur given these comparably high grid voltages. Such a focusing electrode is therefore presently, advantageously omitted. Moreover, the advantage of an optimally parallel electron beam that enters into the quadrupole doublet is thereby achieved. A very effective focusing and deflection via the quadrupole systems is ensured via the high degree of parallelism.

Electrons that severely deviate from the otherwise parallel beam direction can exit from the border regions of the emitter. In the sense of a fine optimization, in an another embodiment, only a fine focusing is provided. For this, a low voltage (advantageously of only 50 V) relative to the cathode potential is applied to what is known as a focus head (which is directly associated with the emitter). This voltage can be generated with comparably simple means, such that overall the electronic control unit is of simpler design.

The object is furthermore achieved by a method for operation of the x-ray tube wherein the electron beam is focused by two quadrupole magnet systems as described above. Overall, the operation of the x-ray tube at comparably low tube voltages (for example of approximately 70 kV) given simultaneously high tube current (of 1500 mA, for example) is achieved via the design described here—in particular the combination of the two quadrupole systems—together with a thermal emitter enlarged in comparison to the prior art.

### BRIEF DESCRIPTION OF THE DRAWINGS

FIG. 1 shows a rotary envelope x-ray radiator in a schematic side view.

FIG. 2 shows a first variant of a quadrupole magnet system of the x-ray radiator according to FIG. 1.

FIG. 3 shows a second variant of a quadrupole magnet system of the x-ray radiator according to FIG. 1.

### DESCRIPTION OF THE PREFERRED EMBODIMENTS

A rotary envelope x-ray radiator (also designated as an x-ray tube for short) that is designated as a whole with the reference character 1 has an evacuated housing 2 (which is also designated as a rotary envelope). The prior art cited above is referenced with regard to the principle function of the x-ray tube 1.

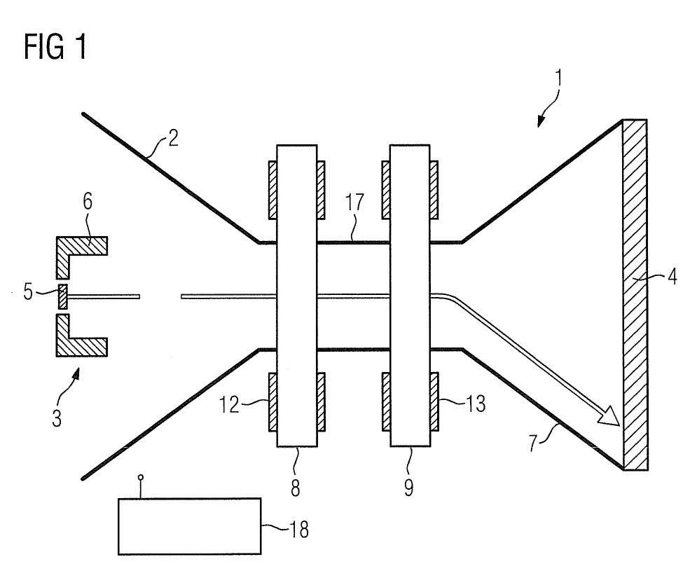

Arranged in the housing 2 are an electron source 3 on the one side and a disc-shaped anode 4 on the other side. The electron source 3 has a cathode 5 as an emitter and a focus head 6. The direction of the electron beam emanating from the cathode 5 is initially identical with the attenuation of the rotation axis of the housing 2. A drive device with which the housing 2 is set into rotation is not shown in FIG. 1.

The housing 2 has a funnel-shaped expansion pointing towards the anode 4, which has a significantly larger radial extent (relative to the rotation axis of the housing 2) in comparison to the electron source 3. In the region between the electron source 3 and the expansion 7, the housing 2 is surrounded by a first quadrupole magnet system 8 and a second quadrupole magnet system 9. The axis of symmetry of each quadrupole magnet system 8, 9 coincides with the rotation axis of the housing 2. In contrast to the housing 2, the quadrupole magnet systems 8, 9 do not rotate.

While the first quadrupole magnet system 9 primarily influences the electron beam in the horizontal direction (for example), according to this example the second quadrupole magnet system 9 primarily influences the electron beam in the vertical direction. An electron beam emanating from the emitter 5, striking the anode 4, is indicated by an arrow in FIG. 1.

The two quadrupole magnet systems 8, 9 are identically designed and dimensioned and are coaxial, but are installed rotated 90° relative to one another. The clearance between the two quadrupole magnet systems 8, 9 corresponds to at least the thickness—measured in the axial direction, i.e. in the direction of the rotation axis of the housing 2—of each quadrupole magnet system 8, 9. The total thickness (i.e. the distance measured in the axial direction) of the arrangement of the quadrupole magnet systems 8, 9 is less than the largest radial extent of the quadrupole magnet systems 8, 9.

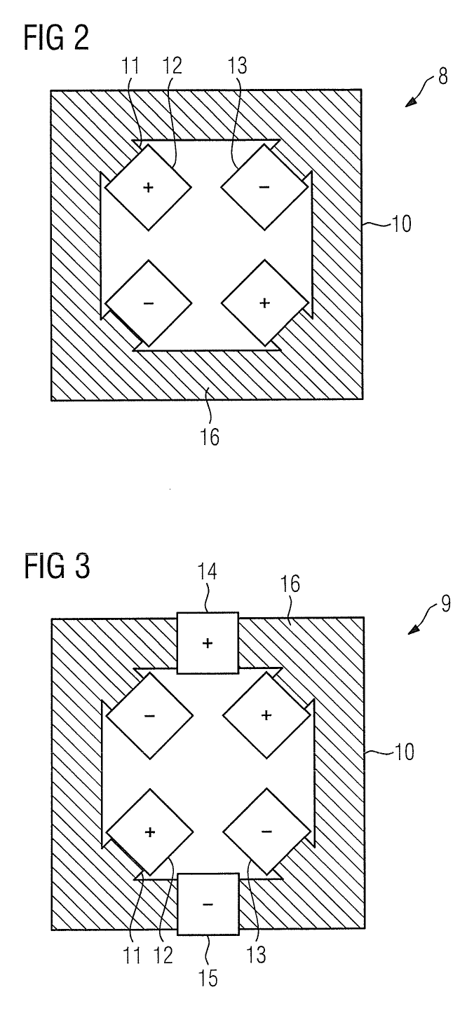

Possible embodiments of the quadrupole magnet systems 8, 9 are shown in FIGS. 2 and 3, wherein each of the embodiments is usable both as a first magnet system 8 arranged closer to the cathode 5 and as a second magnet system 9 arranged closer to the anode 4.

A frame-shaped, quadratic yoke 10 which has a respective, diagonally inwardly directed yoke pin 11 at its corners is apparent in the exemplary embodiment in FIG. 2. A quadrupole coil 12, 13 is located at each of these yoke pins 11, wherein the shown polarities are to be considered examples. For instance, while the quadrupole magnet system 8 has the polarity according to FIG. 2, in the second quadrupole magnet system 9 the polarities are swapped, which is equivalent to the aforementioned rotation of the two quadrupole magnet systems 8, 9 by 90° relative to one another.

In the arrangement according to FIG. 3, in addition to the quadrupole coils 12, 13 two dipole coils 14, 15 are arranged on the yoke 10, namely respectively on one of four side pieces 16 of the frame-shaped yoke 10. As an alternative to the presented variant, the side pieces 16 can also be curved. By the arrangement of the quadrupole coils 12, 13 within the frame formed by the side pieces 16 and the arrangement of the dipole coils 14, 15 on this frame, the quadrupole coils 12, 13 are not spaced as far apart from the rotation axis of the housing 2 as the dipole coils 14, 15.

The operation of the x-ray tube is controlled via a control device 18 schematically shown in FIG. 1. The x-ray tube 1 operating with the quadrupole magnet systems 8, 9 is designed for very high tube currents (of 1500 mA, for example) given a low tube voltage (i.e. voltage between cathode 5 and anode 4) of 70 kV, for example. The x-ray tube 1 is therefore very suitable for medical applications with low dose exposure for the patient. At the same time, a very high image quality can be achieved via the sharpness of the focal spot on the anode 4 that is achieved with the aid of the double quadrupole magnet system 8, 9. For the durability of the electron source 3 it is particularly advantageous that no grid voltage (as it is known) is required at the electron source 3 for focusing purposes to operate the x-ray tube 1, and it is also not provided. In particular, the emission area of the cathode is dimensioned relatively large. While an electron beam with relatively large cross section is emitted in comparison to conventional x-ray tubes, a particularly precise focusing of the electrons only after their exit from the focus head 6 takes place by means of the quadrupole magnet systems 8, 9 connected in series and matched to one another, wherein these enclose a cylindrical segment 17 of the housing 2 without additional space requirement in comparison to a conventional x-ray tube with single quadrupole magnet system.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray tube comprising:
an evacuated housing mounted for rotation around a rotational axis;
a cathode and an anode inside said evacuated housing, said cathode being configured to emit an electron beam that strikes the anode to cause emission of x-rays from the anode;
a first quadrupole magnet system located outside of said housing and configured to generate a magnetic field that interacts with said electron beam to influence said electron beam between said cathode and said anode; and
a second quadrupole magnet system spaced from said first quadrupole magnet system and configured to also generate a magnetic field that interacts with said electron beam to also influence said electron beam between said cathode and said anode.

2. An x-ray tube as claimed in claim 1 wherein said second quadrupole magnet system is also located outside of said evacuated housing.

3. An x-ray tube as claimed in claim 1 wherein said second quadrupole magnet system is rotated around said rotation axis with respect to said first quadrupole magnet system.

4. An x-ray tube as claimed in claim 3 wherein said second quadrupole magnet system is rotated by 90° relative to said first quadrupole magnet system.

5. An x-ray tube as claimed in claim 4 wherein said first and second quadrupole magnet systems have identical dimensions.

6. An x-ray tube as claimed in claim 4 wherein at least one of said first and second quadrupole magnet system comprises two dipole coils in addition to four quadrupole coils.

7. An x-ray tube as claimed in claim 6 wherein said at least one of said quadrupole magnet systems comprises a yoke with said quadrupole coils thereof being respectively located at corners of said yoke and said dipole coils being located at opposite sides of said yoke.

8. An x-ray tube as claimed in claim 1 wherein said cathode is a thermal electron emitter.

9. An x-ray tube as claimed in claim 8 wherein said emitter comprises a focus head configured to provide an adjustment potential that interacts with said electron beam of at most 100 volts.

10. An x-ray tube as claimed in claim 8 wherein said emitter comprises a focus head configured to provide an adjustment potential that interacts with said electron beam of at most 50 volts.

11. A method for operating an x-ray tube comprising:
providing a cathode and an anode inside an evacuated, rotatable housing;
operating said cathode to emit an electron beam that strikes said anode to cause emission of x-rays from the anode; and
influencing said electron beam between said cathode and said anode with each of first and second quadrupole magnet systems that are located outside of said housing between said cathode and said anode.

12. A method as claimed in claim 11 wherein said cathode is a thermal emitter having a diameter greater than or equal to 8 mm, and operating said x-ray tube with a tube voltage of approximately 70 kV between the cathode and the anode to produce a tube current of approximately 1500 mA.
